(19) United States
(12) Patent Application Publication
(10) Pub. No.: US 2003/0093355 A1
(43) Pub. Date: May 15, 2003

(54) METHOD, SYSTEM AND COMPUTER SITE FOR CONDUCTING AN ONLINE AUCTION

(75) Inventor: GABRIEL N. ISSA, BLOOMFIELD HILLS, MI (US)

Correspondence Address: BROOKS & KUSHMAN, 1000 TOWN CENTER 22ND FL, SOUTHFIELD, MI, 48075

(73) Assignee: GABRIEL N. ISSA, LLC

(21) Appl. No.: 09/373,141

(22) Filed: Aug. 12, 1999

(51) Int. Cl. G06F 17/60

(52) U.S. Cl. 705/37

(57) ABSTRACT

An Internet auction method, system and computer site where independent and/or unrelated buyers are automatically pooled to buy products/services as a group in order to entice competitive bidding from pre-approved sellers who take advantage of the large group sales to bid (offer) discounts. The buyers purchase ‘buying power’ or ‘value’ from a winning seller, not a specific product/service at a specific price. In this way, buyers who have interest in a similar product type, join an auction pool to commit to a spending amount based on a discount rate they desire. Sellers competitively bid to win that pooled sales amount. The seller or sellers having the greatest discount and best meeting the buyer's individual conditions wins the business. All buyers who requested the winning bid discount rate or less, receive ‘buying power’ redeemable at that seller.

### CROSS-REFERENCE TO RELATED APPLICATION

This application is related to copending U.S. patent application entitled “Method and Computer Site for Clearing Sales Transactions”, filed on the same day as this application.

### TECHNICAL FIELD

This application relates to methods, systems and computer sites for conducting online auctions in which the sellers perform the bidding as opposed to the buyers.

### BACKGROUND ART

A reverse auction is an auction in which sellers perform the bidding as opposed to the buyers. Many companies use a variation of a reverse auction at the following Web sites:

| | | |
|---|---|---|
| Mercata.com | Priceline.com | TravelBids.com |
| PriceDrop.com | Cattleofferings.com* | Asianoverstock.com |
| XSChem.com | Flightbids.com | Targetshop.com |
| Shop4u.com | Corphq.com | Targetshop.com |

*(IAS) Internet Auction Service - Related sites which operate under the Cattle Offerings Worldwide Inc. Umbrella: AG Chemical (www.agchemical.com): IAS Hay Market

Mercata.com is a retail site that has a lineup of 1000 products from 150 manufacturers. Prices on the items go down as more people sign up to buy them during a preset period of time.

Selected items are offered as “PowerBuys” (limited-time purchase opportunities), where:

You may pool your buying power with other shoppers who are also interested in the specific item you want to buy.

You set the maximum price you want to pay by making an offer.

The more people who participate, the lower the price drops.

If your offer is accepted, you pay the lowest price achieved by the group.

Priceline.com allows the buyer to name the price they are willing to pay for airline tickets, hotel rooms, home financing, and cars. There is no “auction”, no bidding, and buyers are unable to pool their resources to obtain a better price. Once a buyer has submitted a request he is locked into the purchase if Priceline is successful in meeting the buyer's requirements. However, the buyer is unable to determine what time he departs from either city. Priceline's policy is all flights will be regularly scheduled to depart between 6:00 a.m. and 10:00 p.m., arriving the same day. Credit card payment is the only form of payment Priceline will accept online, currently.

TravelBids.com is another Internet site where a buyer can purchase airline tickets. However, with TravelBids the buyer goes out and makes the reservations, but does not pay. The buyer then posts the listing of the reservation on TravelBids.com where travel agents may view the listing and bid on it. The buyer must pay a $5.00 fee for posting the listing and the listing must be more than $250.00 in value. The “winning” agent then takes over the reservation that was made, charges the buyers' credit card, and sends all pertinent info via mail. Currently, TravelBids only accepts Visa, American Express and MasterCard online.

PriceDrop.com posts dozens of items each morning and lowers the price on each item hourly throughout the day, until a buyer purchases it. If no one buys the item, the cycle ends at midnight and begins again the next day. Under this model the price of the item will continue to drop until someone buys the item.

Cattleofferings.com provides a marketplace for farmers looking for agricultural supplies for their farms. The buyer simply fills out a form detailing personal information as well as specific information about the desired product. Then, at a posted time, the reverse auction begins whereby the lowest bidder has the opportunity to supply the farmer with the desired product. There are 2 options available to buyers to process the transaction:

1. Cattle Offerings Worldwide holds the funds in escrow until the merchant delivers the product.

2. The farmer uses a farm credit processing agency to insure its credit arrangements with the merchant. All buyers and merchants must be registered with Cattle Offerings. All auctions are completed in real time using a Java based application. The aforementioned characteristics are the same for both the hay Market and the AG Chemical auctions.

Asianoverstock.com is a Web site enabling distributors to obtain merchandise from the Far East while at the same time aiding the factories there by having an online, realtime advertising medium for their excess items. Asianoverstock.com's reverse auction does not allow for the pooling of buyer resources. It requires each buyer to fill out a form detailing what the product is they are looking for. Asianoverstock.com then searches out bids for that product and returns the information to the buyer. Payment terms are determined based on the quantity desired as well as shipping.

XSChem.com is a forum which facilitates the buying and selling of agricultural chemicals. This site is also a one buyer to many merchants format. XSChem.com has a prefabricated form with drop down menus detailing the brand and sizes of products that are available. Buyers also have the ability to specify the maximum price they will pay, age of the product and the end date of the listing. Transaction processing is done through ACH funds transfers. The transaction cannot begin until funds are received in the secure lock box at First Union National Bank. Once a bid is accepted, the ACH transaction is executed the following day. If funds are not sufficient, the transaction is rejected, effectively nullifying the bid contract.

AgChemical.com is a reverse auction site for agricultural chemicals. A buyer fills out a request form for a particular chemical and the seller bids to fill the requested order.

FlightBids.com—Currently, people may only use this site to book flights out of the UK. Here again buyers name the price they are willing to pay for the ticket and merchants either agree or disagree to the price. There is no charge to make a flight bid. When making a listing you are only able to specify the month in which you would like to depart and the length of your stay in days. There is a minimum flight bid of $100.00. Payment terms are not discussed.

TargetShop.com is an Internet shopping mall where merchants are qualified and approved as credible for selling their goods. Consumers who become buying members are promised a discount for all goods (20%). The merchants are promised to have access to 8 to 10 million shoppers in order to entice them to join and offer the discount to buying members. Although it offers goods at a discount, there is no pooling of buyers, no competitive selling and no auction.

Shop4u.com is a basic Internet virtual mall with a blank form where buyers have the ability to describe the product they are looking for, including a maximum price, and Shop4u.com will search out the best available price. Also, other users of Shop4u.com are rewarded for doing the searching for product listings as well. Shop4u.com does not sell any of the products they list in their site, nor can you purchase anything off their site. This is simply a bargain site where people can come and find the lowest prices for products.

CorpHQ.com is a business platform designed to provide today's entrepreneur with all of the advantages of a large company, and none of the disadvantages. This is done by uniting independent professionals through the Internet and providing them with a real-world network of sales people and mainstream advertising campaigns. Corphq.com offers a reverse auction where people can place requests for products and services from the members of Corphq.com. Payment options are credit cards, 50% deposit/balance COD (all first time orders), COD, Line of Credit. Responses to a post will take up to 4 business days. Must include maximum price buyer is willing to pay.

Godin, et al. (U.S. Pat. No. 5,890,138) discloses a computer auction system using a reverse auction scheme in selling specified products. The reverse auction scheme is a traditional reverse auction where the price for the product starts at an opening price and decreases in pre-determined increments until all the products are sold or the auction time runs out. Buyers log into the system and view the products up for auction and bid for the product when the price of the product reaches a desired level.

Brown (U.S. Pat. No. 5,794,219) discloses a method of conducting an online auction that incorporates pooling of bids. Bidding groups are established before the starting of the auction and the user joins in on one of the groups to increase the value of the bidding pot for that group. The product is sold to the group with the highest pooled bid at the end of the auction period.

Giovannoli (U.S. Pat. No. 5,758,328) discloses a computerized quotation system, which provides a centralized hub for buyers and sellers. A buyer logs onto the network and places a request for a particular product/service. A seller logs onto the network and reviews the listed requests and notifies the potential buyer with a price quote for the requested product/service.

Rossides (U.S. Pat. No. 5,620,182) discloses an expected value payment system for reducing the expected per unit costs of a given amount of commodity. A buyer “bets” for an amount of commodity in an effort to receive the commodity at a lower per unit cost typically available only for high bulk purchases. The bet winner is chosen based on a random number generator.

U.S. Pat. Nos. 5,797,127 and 5,883,810 are also related to the present invention.

### DISCLOSURE OF INVENTION

An object of the present invention is to provide a method, system and computer site for conducting an online auction wherein the buying transaction is separated from the process of selecting the exact variation/options of the item and from the process of redeeming the item.

In carrying out the above-object and other objects of the present invention a method is provided for conducting an online auction of a monetary amount for a specified category of items. The method includes receiving at a computer site at least one bid having a discount rate for the specified category of items being auctioned from a plurality of sellers registered to participate in the auction. The method also includes receiving at the computer site a commitment to buy an undiscounted value amount within the specified category of items at a minimum discount rate from at least one buyer registered to participate in the auction. The method then includes declaring at least one successful seller of the value amount for the specified category of items based on a bid from the successful seller or sellers having the greatest discount rate greater than or equal to the minimum discount rate and best meeting the buyers' individual conditions.

A commitment to buy an undiscounted value amount at a minimum discount rate may be received from each of a plurality of buyers. The method includes pooling the plurality of buyers to obtain various pooled award amounts wherein at least one successful seller is declared of his respective pooled award amount for the specified category of items.

The items may be products or services.

The plurality of buyers may be independent and/or unrelated.

The method may further include receiving at the computer site information representing a minimum award amount or pre-defined sequence of minimum award amounts corresponding to a pre-defined sequence of discount bids that a seller is willing to accept from the pooled buyers.

The method may further include receiving at the computer site information representing a maximum award amount that a seller is capable of accepting and willing to accept from the pooled buyers.

The method may further include receiving at the computer site information representing a method of guaranteeing the value amount from the at least one buyer.

At least one seller is pre-approved to sell the specified item or category of items.

The method may further include receiving at the computer site information representing any sellers unacceptable to the at least one buyer.

The computer site may be a Web site.

The auction may be a reverse auction.

The auction may end a fixed period of time after the auction begins. The method may further include receiving at the computer site a command from at least one buyer to try to end the auction for the buyer or buyers where a successful seller of the value amount for the buyer or buyers can be declared before the preset auction expiration time.

The method may further include receiving at the computer site a command from at least one buyer to try to end the auction for the buyer or buyers wherein a successful seller of the value amount for the buyer or buyers can be declared before the end of the auction.

The successful seller may be determined by the buyer's predefined conditions.

The seller with the highest bid for discount rate may be the successful seller.

There may be more than one successful seller for a given auction.

Buyer and seller accounts may be registered to each buyer and seller. Each account may incorporate various inter-linked sub-accounts and can also be linked to a buyer's or seller's external accounts held by other participating financial institutions.

In order to fund the buyer account or to effect payments from it, funds can be transferred between the various sub-accounts and external accounts held by a financial institution. Also, a buyer could transfer funds or reassign buying power amounts to the account of another buyer or seller.

Still further in carrying out the above object and other objects of the present invention is a computer site for conducting an online auction of a monetary amount for a specified category of items is provided. The computer site includes a set of related documents and associated files and a server for serving up the set of related documents and associated files to a plurality of I/O devices to provide buyers and sellers with capability to participate in the auction. The server is programmed with application software to: 1) receive at least one bid having a discount rate for the specified item or category of items being auctioned from a plurality of sellers registered to participate in the auction; 2) receive a commitment to buy an undiscounted value amount of the item or an undiscounted value amount within the specified category of items at a minimum discount rate from at least one buyer registered to participate in the auction; and 3) declare at least one successful seller of the value amount for the specified item or category of items based on a bid from the successful seller or sellers having the greatest discount rate greater than or equal to the minimum discount rate and best meeting the buyers' individual conditions.

A commitment to buy an undiscounted value amount at a minimum discount rate is typically received from each of a plurality of buyers. The server is then further programmed to pool the plurality of buyers to obtain various pooled award amounts wherein the at least one successful seller is declared of his respective pooled award amount for the specified category of items.

The items may be products or services.

The plurality of buyers may be independent and/or unrelated.

The server may be further programmed to receive information representing a minimum award amount or pre-defined sequence of minimum award amounts corresponding to a pre-defined sequence of discount bids that a seller is willing to accept from the pooled buyers.

The server may be further programmed to receive information representing a maximum award amount that a seller is capable of accepting and willing to accept from the pooled buyers.

The server may be further programmed to receive information representing a method of guaranteeing the value amount from the at least one buyer.

At least one seller is pre-approved to sell the specified item or category of items.

The server may be further programmed to receive information representing any sellers unacceptable to the at least one buyer.

The computer site may be a Web site.

The auction may be a reverse auction.

The auction may end a fixed period of time after the auction begins.

Alternatively, the server may be further programmed to receive a command from at least one buyer to try to end the auction for the buyer or buyers wherein a successful seller of the value amount for the buyer or buyers can be declared before the preset auction expiration time.

The server may be further programmed to receive a command from the at least one buyer to try to end the auction for the at least one buyer wherein a successful seller of the value amount for the at least one buyer can be declared before the end of the auction.

The successful seller may be determined by the buyer's predefined conditions.

The seller with the highest bid for discount rate may be the successful seller.

There may be more than one successful seller for a given auction.

Buyer and seller accounts may be registered to each buyer and seller. Each account may incorporate various inter-linked sub-accounts and can also be linked to a buyer's or seller's external accounts held by other participating financial institutions.

In order to fund the buyer account or to effect payments from it, funds can be transferred between the various sub-accounts and external accounts held by a financial institution. Also, a buyer could transfer funds or reassign buying power amounts to the account of another buyer or seller.

Yet still further in carrying out the above object and other objects of the present invention a computer-implemented auction system for negotiating discount credits between sellers offering at least one pre-defined category of goods or service items and buyers wishing to purchase goods or service items selected from said category is provided. The auction system presents a first interface for access by buyers in communicating willingness to purchase items selected from a pre-defined category at a negotiated category discount and a second interface for access by sellers in communicating willingness to offer items selected from the pre-defined category. The first interface includes a commitment amount field through which each buyer communicates the amount that buyer will commit to spend and a requested discount field through which each buyer communicates the smallest discount that buyer will accept. The auction system also includes a data storage associated with the auction engine for storing the identity of buyers who have communicated willingness to purchase items from the pre-defined category, and for storing bid data indicative of the commitment amount and requested discount communicated by each buyer. The auction system further has a compilation system that analyzes the bid data to present information to sellers through the second interface indicative of the aggregate commitment amounts associated with different requested discounts. The second interface has a discount offer field through which each seller communicates the discount or sequence of discounts that seller is willing to offer. The auction system further includes a commitment system having a mechanism for terminating negotiation in response to a pre-defined criterion and for identifying a selected seller that has met the pre-defined buyers' requirements. The commitment system communicates with the auction system to generate a discount record for at least a portion of the buyers identified in the data store. Each discount record includes the identity of the buyer and seller, the pre-defined category on which the buyer negotiated and data indicative of the commitment amount and the discount offered by the selected seller.

The term “buying power”, as used in this description, is intended to describe “the ability and the right to purchase a certain monetary amount's worth of a certain item or category of items”.

The auction site of the invention has the following characteristics:

independent and/or unrelated buyers are automatically pooled together into one buying group based on a category of products/services they are seeking to buy as opposed to just one specific product/service

each buy order can specify a category of products/services as opposed to just one specific product/service

each filled buy order gives the buyer the right to buy from a specified seller (and commits the buyer to buy from a specified seller) a certain monetary amount worth of a category of products/services as opposed to just one specific product/service for one specific price

multiple sellers compete to fill pooled orders by bidding down the pooled amounts (offering higher discounts)

pooled orders amounts are awarded to the seller or sellers offering the highest discount and meeting individual order conditions. Awarded amounts give the seller or sellers the right to sell (and commits the seller or sellers to sell) such amounts worth of the category of products/services at the offered discount.

The following items make the auction site of the invention substantially different from existing Internet auctions:

1) Multiple sellers compete by bidding down (increasing discounts on) the pooled amounts, resulting in higher discounts.

2) Automatic and dynamic pooling of buyers allows the grouping of disparate buyers without the need for prior planning and organization of such groups.

3) Having the buyer specify a value amount as opposed to an exact price, and a category of products/services as opposed to a specific product/service, offers many advantages, such as:

Products/services with many variations/options for which it is difficult to specify an exact price before the sale can still be auctioned by including them into a more generalized category from which the buyer agrees to buy a certain monetary amount (e.g. $30,000 worth of XYZ model automobile). This will result in the creation of large auction pools.

Categories of products/services that are similar, but not identical, can be grouped and offered into one auction, resulting in even larger auction pools and greater discounts (e.g. $2,000 worth of XYZ PC computers and XYZ printers).

4) The separation of the buying transaction from the process of selecting the exact variation/options of the item and from the process of redeeming the item has many advantages, such as:

Enables the auctioning of blocks of products/services that are normally bought/used in a fragmented manner (e.g. $500.00 worth of long distance calls).

Enables the auctioning of products/services that buyers traditionally like to physically inspect or try out before purchasing (e.g. $200.00 worth of women's apparel).

Enables the buyers to first secure a discount on a sale, then take enough time selecting the product/service that best fits their needs (e.g. $3,000.00 worth of home carpeting).

Enables the sellers to advance sell without having to wait for buyers to select or redeem the product/services (e.g. XYZ Mall winning a pool of $700,000.00 worth of discounted gift certificates).

This auction will increase sales for sellers and, at the same time, allow all consumers to receive reduced prices on products/services at the same places at which they usually shop. The method and computer site of the invention provides the following benefits:

This model enables the auctioning of practically any common product/service.

This is a true real-time marketplace governed by the natural economic laws of supply and demand.

The model is a powerful medium for corporate procurement of commonly used products/services.

The model is a powerful medium for sellers (both national chains and local merchants) to advance sell large quantities of merchandise.

Merchants will be able to sell large volumes of goods/services from a central point instead of relying on the merchant's efforts to generate sales based on corporate-funded advertising and promotions. The result will be an increase in sales without offsetting the revenues from existing, traditional sales methods.

Merchants could achieve major short-term sales targets by offering a mass discount on the auction site. This will greatly assist corporations with meeting and exceeding sales volume targets.

For goods/services that don't usually offer reduced or sale prices (e.g. restaurants), the consumers will be able to buy these goods/services at discounted prices.

For goods/services that inherently provide a bargaining environment (e.g. automobiles), the buyer can avoid the sometimes uncomfortable and questionable negotiation tactics of the sellers and still be assured that they are receiving a low price.

Consumers or corporations who need to maintain a budget can pre-purchase exact amounts of different goods/services to match their budgets for these goods/services.

In many cases, the sales for corporations will be over and above their normal commercial sales.

It will offer corporations a cost effective channel for marketing, saving them a great deal of money spent on expensive advertising and traditional marketing campaigns.

Excellent marketplace for the liquidation of overstock, closeout, and surplus products.

Effective marketing tool for the introduction of new products/services as well as test marketing for consumer acceptance of new products/services.

The above objects and other objects, features, and advantages of the present invention are readily apparent from the following detailed description of the best mode for carrying out the invention when taken in connection with the accompanying drawings.

### BRIEF DESCRIPTION OF DRAWINGS

FIG. 1 is a block diagram schematic flow chart illustrating a method, system and computer site for conducting an online auction;

FIG. 2a is a block diagram flow chart illustrating the seller's perspective of the auction;

FIG. 2b is a block diagram flow chart illustrating the buyer's perspective of the auction;

FIG. 3a is a schematic view of a screen display on a seller's monitor;

FIG. 3b is a schematic view of a screen display on a buyer's monitor;

FIG. 4 is a block diagram flow chart illustrating a time-limited auction with multiple awardees (method 1);

FIG. 5 is a block diagram schematic flow chart illustrating a method and computer site for clearing sales transactions;

FIG. 6 is a block diagram flow chart illustrating the sales clearing process; and

FIG. 7 is a schematic view of a set of interconnected industries and financial institutions which can utilize the method, system and computer site for clearing sales transactions.

### BEST MODE FOR CARRYING OUT THE INVENTION

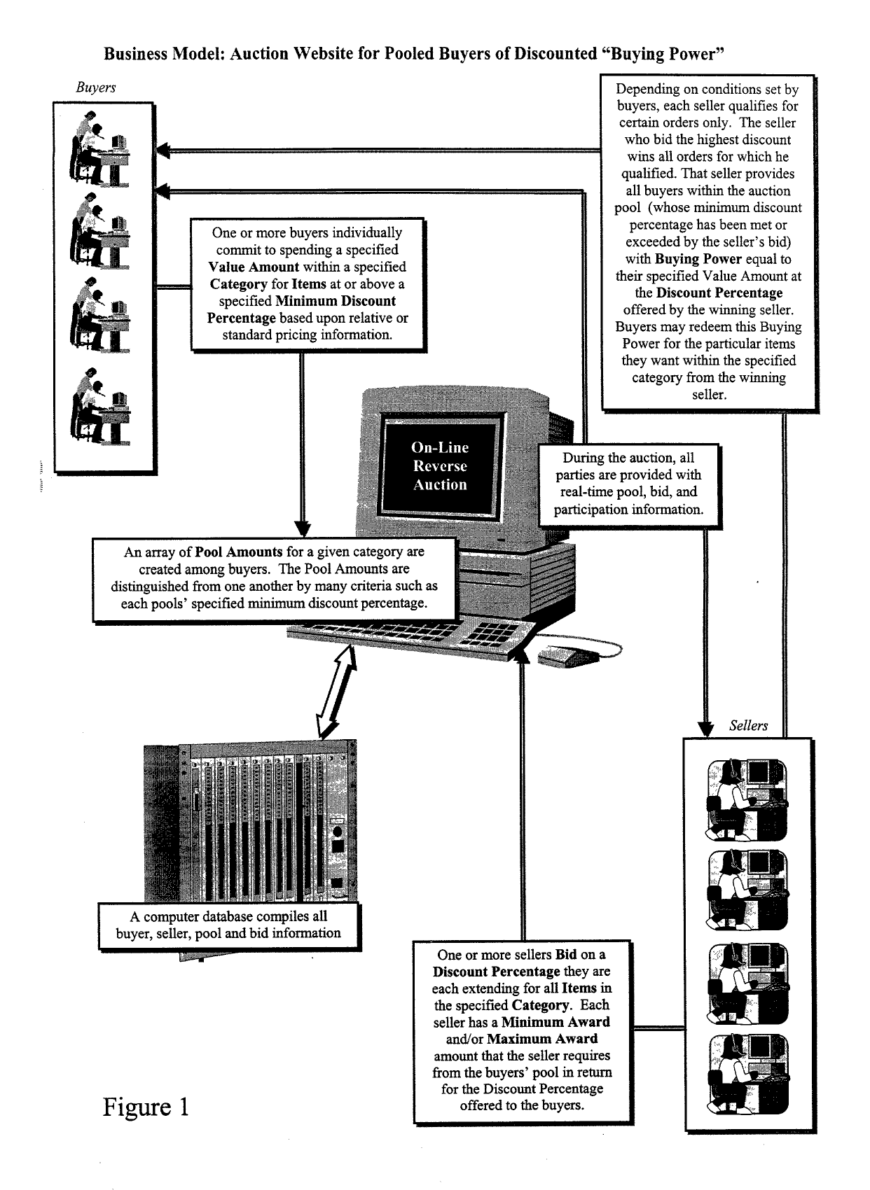

In general, a method, system and computer site for conducting an online auction is illustrated in FIG. 1. The computer or Web site typically includes a site administrator which maintains, publishes and updates a list of items (a list of goods/products/services) to be auctioned through the site. Items are added to (or removed from) the list of items based on requests from buyers, offers from sellers and/or market trends and conditions.

An “item” is herein defined as any merchandise/product/service or any category of merchandise/products/services that can be unequivocally described/specified so to constitute a “distinct commodity” suitable to be traded/auctioned through the site. In other words, it is an “auction item”. The description/specification that constitutes an “item” can be very specific or quite encompassing. However, an “item” should generally incorporate the following characteristics:

An item should be sufficiently specific to reflect a known commodity that is commonly traded.

When an item is specified to encompass a category of merchandise/products/services, the category should generally be limited to things that can normally all be bought at the same place (from the same seller).

When an item is specified to encompass a category of merchandise/products/services, the category should be limited to things that can be discounted uniformly (same discount rate for all things in category) by sellers.

It must be possible to determine an undiscounted regular price for an item to be used as the base price on which buyers request a discount and sellers offer a discount. The description/specification of the item should include one or more method for determining its undiscounted regular price. Depending on the type of the item, various methods could be used, such as:

a specific formula or starting unit price (10¢/minute for long-distance calls)

manufacturer suggested retail price (automobiles)

publicly displayed prices (department store, grocery store)

published prices (restaurant menu, printed catalog)

prior quotes from sellers (insurance policy, mortgage)

online catalogs of standard manufacturer suggested list prices

The site typically includes reference information to facilitate determining the undiscounted regular price such as links to independent Web sites offering undiscounted price information or sellers' Web sites that publish prices or offer online quotes, addresses and phone numbers for quote requests, sellers' price lists, etc. The auction site could also develop and publish an online catalog relative to each auction item.

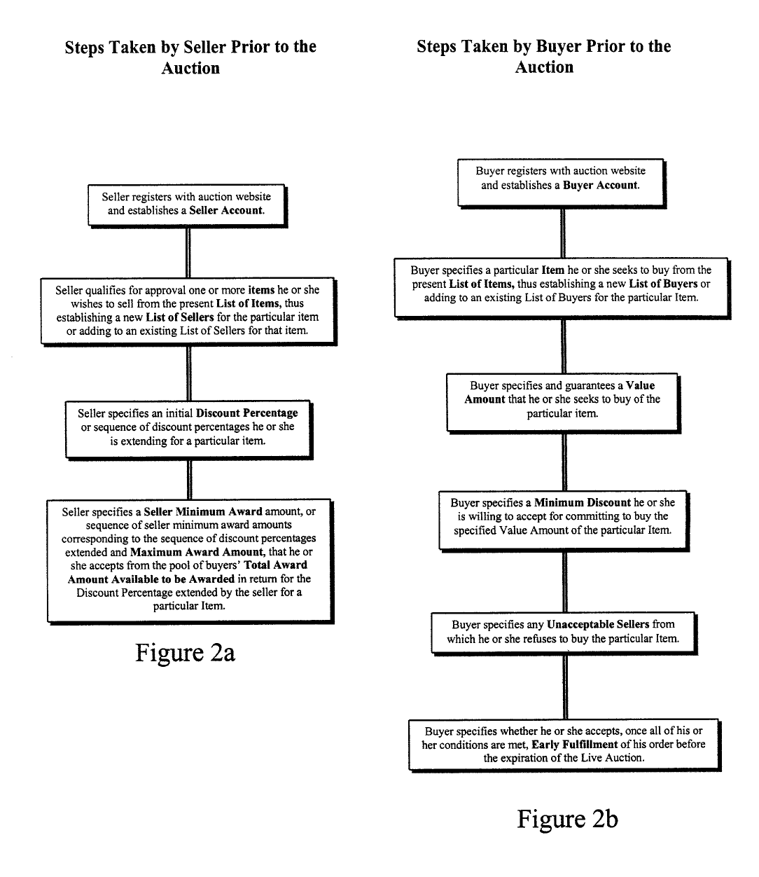

As illustrated in FIG. 2a, each seller initially registers to establish a seller account (see the description of the management system below for an example of a seller account). Subsequently, sellers individually request approval from the site administrator to sell one or more items on the present list of items, thus establishing a list of sellers for each particular item.

As illustrated in FIG. 2b, each buyer registers to establish a buyer account that incorporates various sub-accounts (e.g. cash, credit, escrow sub-accounts) (see the description of the management system declares for an example of a buyer account). Subsequently, buyers individually place one conditional order per item that they seek to buy from the present list of items, thus establishing a list of buyers for each particular item.

A live auction, normally with a set time frame, is initiated for the particular item. Potential participants (buyers and sellers) are notified by various means (e.g. E-mail, advertising, etc.). The live auction could be pre-scheduled, initiated manually by the site administrator or initiated automatically when certain pre-determined criteria are met (e.g. sufficient matched sellers and buyers, sufficient total pool amount, etc.).

One example of bidding is performed by the sellers as opposed to the buyers (an auction format commonly known as reverse auction). Sellers individually bid down their respective seller pool amount by increasing the discount rate offered.

As further illustrated in FIG. 2b, to place an order a buyer specifies:

The particular item he seeks to buy from the present list of items.

A value amount he seeks to buy of the particular item and a method of guaranteeing this value amount (e.g. funds in his buyer account sub-accounts, credit card, etc.).

A minimum discount rate he is willing to accept in return for committing to buy the specified value amount of the particular item.

Any unacceptable sellers—the particular sellers (if any) in the list of sellers from which he refuses to buy the particular item.

Whether he accepts, once all his conditions are met, early fulfillment of his order (before the expiration of the live auction). This entry applies to certain types of auctions only and can be done at any time during the auction.

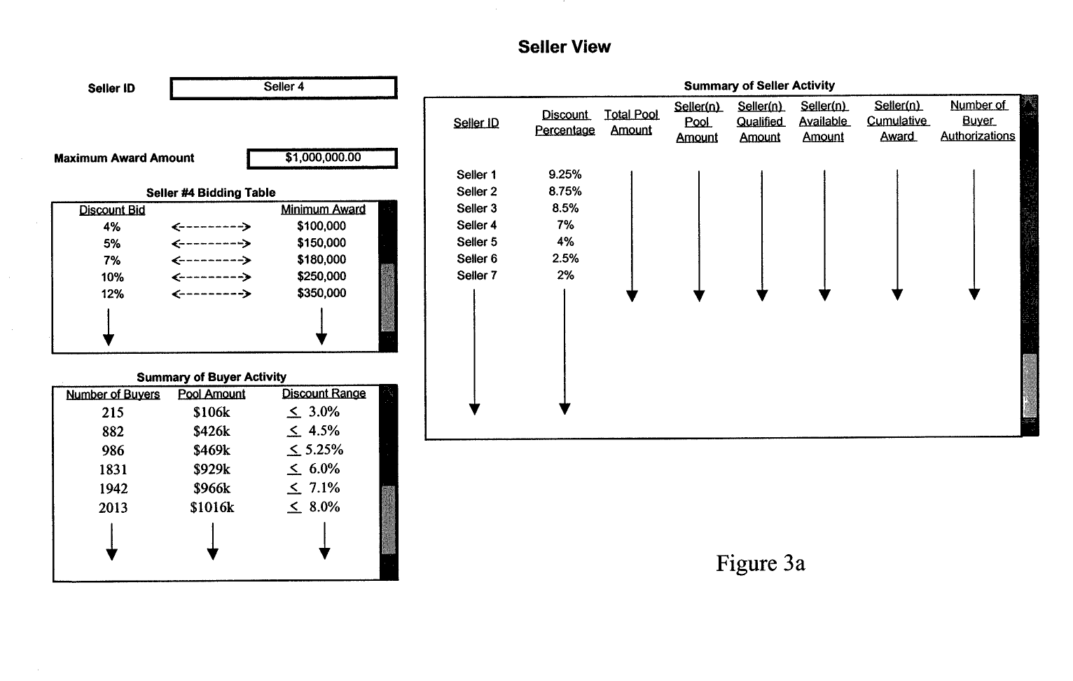

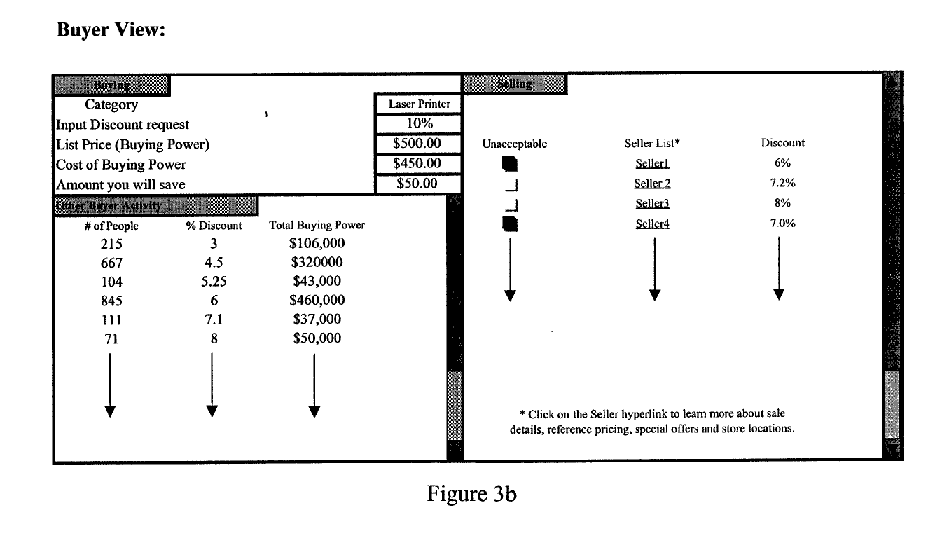

As further illustrated in FIG. 2a and 3a, to place a bid a seller specifies:

A discount rate he is extending.

A seller minimum award amount (not to exceed a pre-determined amount or rate set by the site administrator) he accepts in return for the discount rate he is extending. this entry applies to certain types of auctions only.

A seller maximum award amount he is capable of accepting and willing to accept.

In certain auctions, the seller may specify in advance a pre-defined sequence of discount rates he is extending and a corresponding pre-defined sequence of minimum award amounts.

At any particular time, various pool amounts can be calculated for each particular item by compiling the data from individual buyers' orders and sellers bids such as:

| | | |
|---|---|---|
| Total Pool Amount | = | sum of all orders for the particular item |
| Sellerₙ Pool Amount | = | sum of all orders that did not specify that |
| | | sellerₙ is unacceptable |
| Sellerₙ Qualified | = | sum of all orders included in sellerₙ pool |
| Amount | | amount and whose minimum discount is equal |
| | | to or lower than the discount bid by sellerₙ |
| Sellerₙ Available | = | sum of all orders included in sellerₙ qualified |
| Amount | | amount and that are available to be awarded at |
| | | any particular time during the live auction |
| Sellerₙ Last | = | the last amount awarded to sellerₙ at any |
| Awarded Amount | | particular time during the live auction |
| Sellerₙ Cumulative | = | the cumulative sum of all amounts awarded to |
| Awarded Amount | | Sellerₙ at any particular time during the live |
| | | auction |
| Sellerₙ Cumulative | = | (Sellerₙ cumulative awarded amount) less (the |
| Received Amount | | cumulative discounts he extended) |
| Buyerₙ Paid Amount | = | (value amount in buyerₙ filled order) less |
| | | (discount bid by seller who filled his order) |
| Buyerₙ Order Status | = | filled or unfilled |

Note: The seller pool amount presented to sellers might vary from one seller to another due to the ability of buyers to specify unacceptable sellers.

As illustrated in FIG. 3a, each seller is presented with a set of continually variable data, automatically and dynamically compiled from the aggregate of placed orders and bids for the particular item (e.g. auction time remaining, number of buyers, various pool amounts, weighted average of minimum discount requested, ranking of seller's bid, historical data of previous similar auctions, etc.).

As illustrated in FIG. 3b, during the live auction each buyer is presented with a set of continually variable data, automatically and dynamically compiled from the aggregate of placed orders and bids for the particular item (e.g. auction time remaining, number of buyers, various pool amounts, weighted average of minimum discount requested, order status, historical data of previous similar auctions, etc.).

A particular order becomes “available to be awarded” (available to be filled) at the moment the buyer specifies that he accepts early fulfillment. However, all orders become automatically available to be awarded at the expiration of the live auction.

A “qualified seller” for a particular order is a seller who was not specified as unacceptable in the order and whose discount offered is equal to or exceeds the minimum discount specified in the order.

When supply is limited, Buyers' orders are filled on a first-received basis.

Depending on the particular auction, various methodologies could be used to fill buyers' orders and award orders to sellers, such as:

Time-limited auction with single awardee:

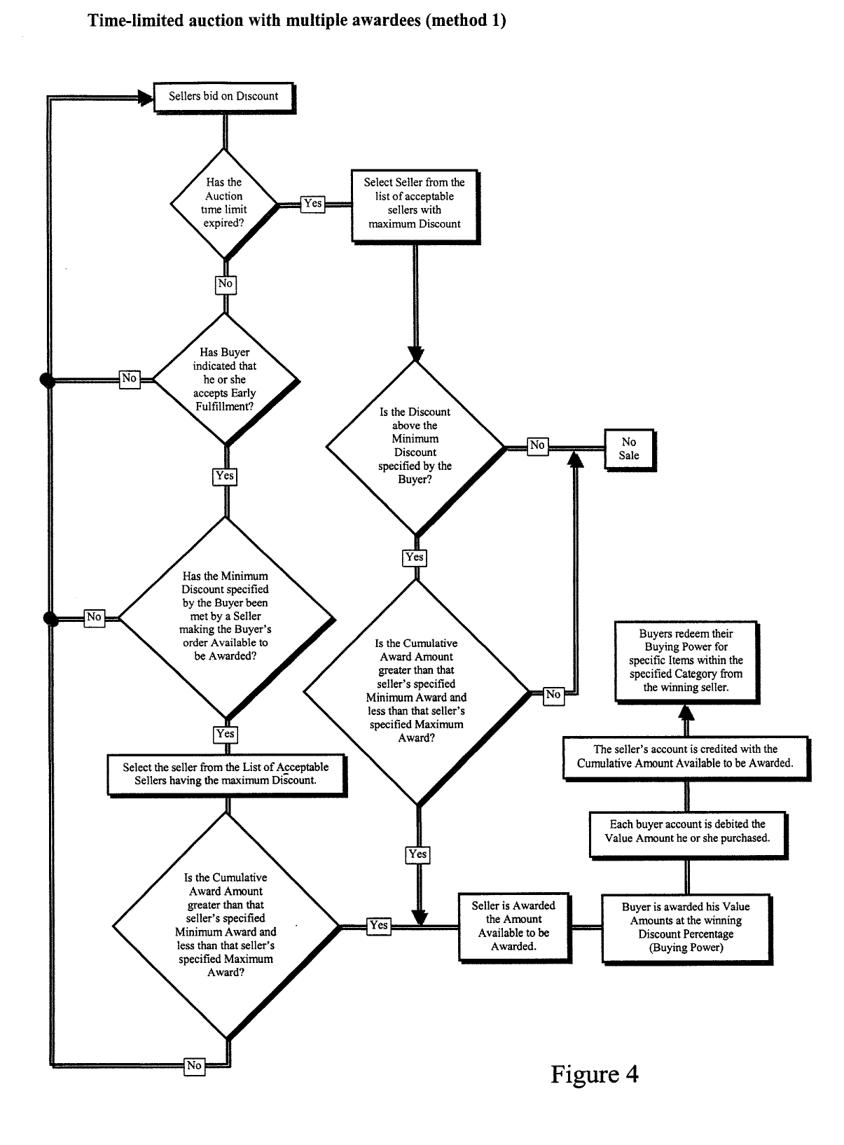

As illustrated in block diagram flow chart form in FIG. 4, buyers cannot accept early fulfillment and orders do not become available to be awarded until the expiration of the live auction. Also, there is no seller minimum award. At the expiration of the live auction, only the seller with the overall winning bid (highest discount) is awarded all the orders for which he “qualifies” up to his specified maximum award amount. Buyers' orders are filled on a first-received basis.

Time-limited auction with multiple awardees (method 1):

In this type of auction, buyers can indicate at any time that they accept early fulfillment, thus making their orders available to be awarded. Sellers can specify a seller minimum award. At any time before the expiration of the live auction, any unfilled order that is available to be awarded can be awarded to a “qualified seller” if the two following criteria are met:

the discount offered by this seller is the highest amongst all “qualified sellers” for this order, and

the cumulative amount available to be awarded, or already awarded, to this seller is equal to or exceeds his specified seller minimum award.

If the maximum award amount is reached for a particular seller, that particular seller is “disqualified” in relation to all remaining unfilled orders and forced to exit the auction with an award amount smaller or equal to his specified maximum award amount.

At the expiration of the live auction, all unfilled orders automatically become available to be awarded. Also, all sellers whose minimum award cannot be met are “disqualified” in relation to all orders and the effect of their bids is nullified. Then, any unfilled order can be awarded to a “qualified seller” if the following criterion is met:

the discount offered by this seller is the highest amongst all “qualified sellers” for this order.

Time-limited auction with multiple awardees (method 2):

In this type of auction, buyers can indicate at any time that they accept early fulfillment, thus making their orders available to be awarded. Sellers can specify a seller minimum award. At any time before the expiration of the live auction, any unfilled order that is available to be awarded can be awarded to a “qualified seller” if the two following criteria are met:

the cumulative amount available to be awarded, or already awarded, to this seller is equal to or exceeds his specified seller minimum award

the discount offered by this seller is the highest amongst all “qualified sellers” whose minimum award has been met.

If the maximum award amount is reached for a particular seller, that particular seller is “disqualified” in relation to all remaining unfilled orders and forced to exit the auction with an award amount smaller or equal to his specified maximum award amount.

At the expiration of the live auction, all unfilled orders automatically become available to be awarded. Also, all sellers whose minimum award cannot be met are “disqualified” in relation to all orders and the effect of their bids is nullified. Then, any unfilled order can be awarded to a “qualified seller” if the following criterion is met:

the discount offered by this seller is the highest amongst all “qualified sellers” for this order

Continuous auction with multiple awardees:

This type of auction is best suited for fast-moving and time-sensitive items. It is an auction without a pre-determined expiration time. Buyers enter the continuously-running auction by placing orders that are available to be awarded immediately. There is no seller minimum award in this auction.

The orders are filled on-the-fly by the “qualified seller” with the highest discount bid at that particular time amongst all “qualified sellers”.

If the maximum award amount is reached for a particular seller, that particular seller is “disqualified” in relation to all remaining unfilled orders and forced to exit the auction with an award amount smaller or equal to his specified maximum award amount.

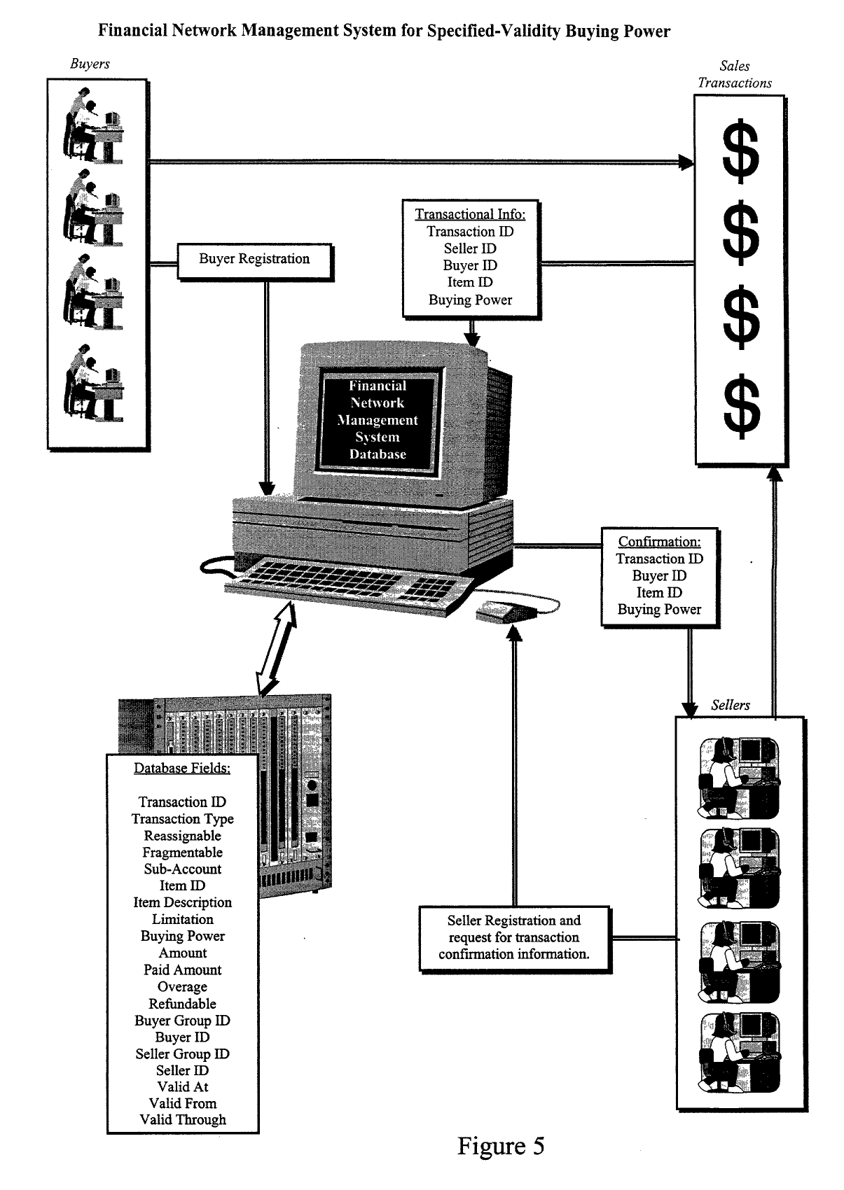

All filled orders are recorded in their respective buyer accounts, and all seller awarded amounts are recorded in their respective seller accounts. All executed transactions are recorded in a database on a transaction by transaction basis. Each transaction is stored as a record in a database incorporating various fields of a database management system as described hereinbelow with respect to a method and computer site for clearing sales transactions as generally illustrated in FIG. 5.

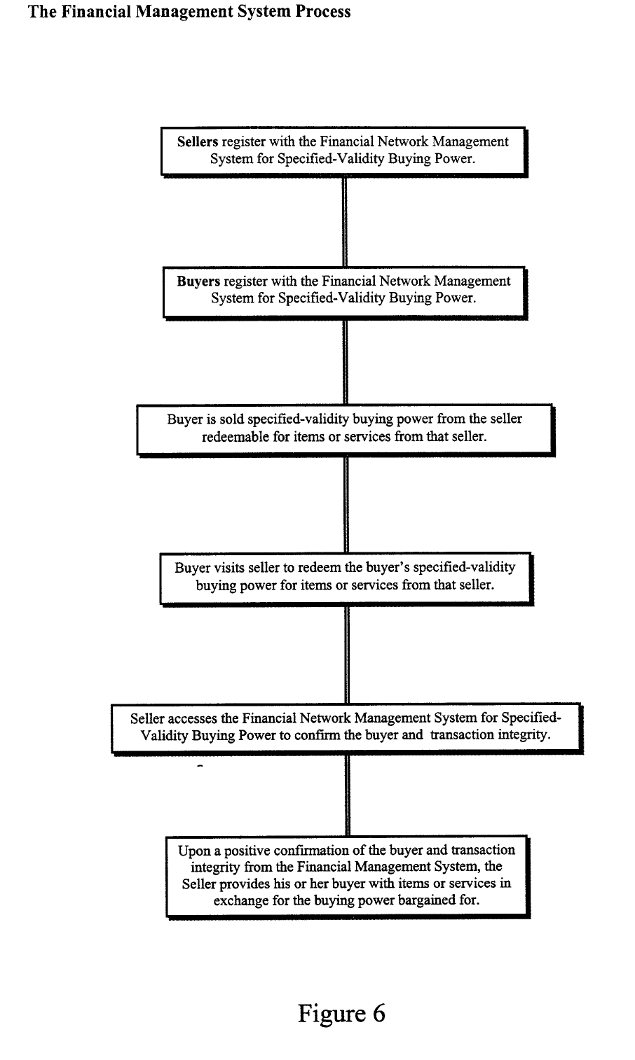

After an auction, as illustrated in FIGS. 1, 4 and 6, each buyer account is debited an amount equal to his buyer paid amount and each seller account is credited an amount equal to his seller cumulative received amount. Depending on the rules set for the particular auction, the debiting/crediting of accounts takes place at one of several possible points in time, such as:

at the time the order is filled/awarded

when the buyer redeems the item (takes possession of the item)

when the seller ships the item

when “escrow” conditions are met

Selection: At this point, the process of selling has been completed as the buyer has purchased a monetary amount of buying power from the seller at a discounted rate. The process of selection now begins by using one of various methods, such as:

going to the seller's physical location/store;

telephone shopping/order placement;

Internet/online ordering.

During the selection process the buyer selects which specific variation/options of the item he desires from the purchased category. (e.g. if the auction item/category was “projection televisions”, then the buyer would select a XYZ 52″ TV model #HDTV2443).

Verification and Processing: To finalize the transaction, the merchant accesses the site database via telephone, computer, cash register or other credit authorization equipment. The electronic transaction handling system authorizes the purchase of X amount of ‘buying power’ for an item or category of items at that seller's location. The system may also (if so designed) allow the buyer a specific amount of “overage/refund” to make additional purchases from that seller at the same discounted rate or to be refunded for unused portion at the same discounted rate.

Redemption/Delivery (taking possession of the specified item): After the selection and verification/processing steps have been completed above, the buyer takes possession of the goods/services by one of many methods, such as:

redeeming the item at the physical retail store;

delivery/shipping from the seller's store or Web site;

by mail (e.g. insurance policy).

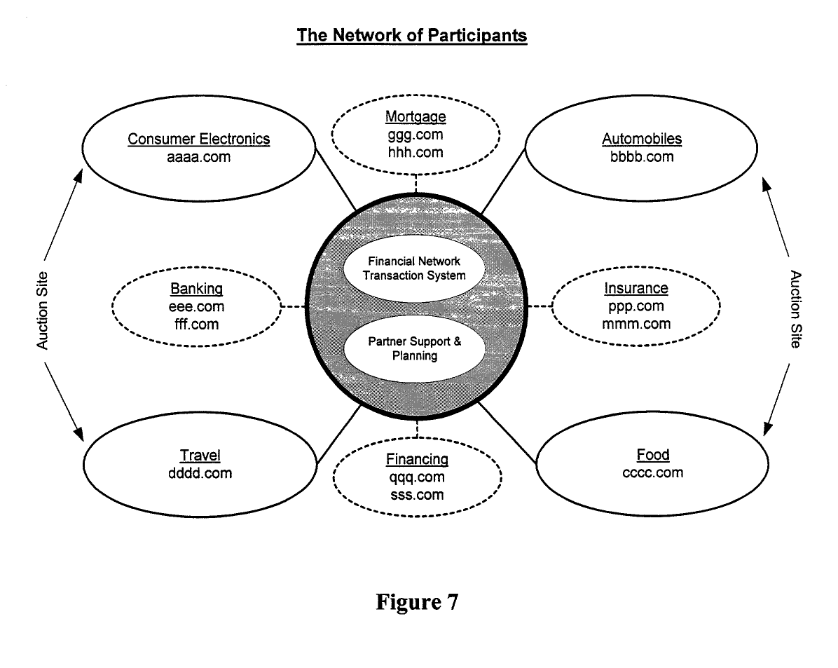

The method and computer site for clearing sales transaction is provided by a database management system (“system”) for a financial network used by participating “sellers” (merchant, manufacturer, provider, institution, etc. as illustrated in FIG. 7) to process, track and manage transactions associated with the trading of “items” (merchandise/product/service or category of merchandise/products/services). At the core of the system is a relational transaction “database”, where:

The rudimentary transaction record specifies a buying power monetary amount that is sold by a specified seller to a specified buyer, and that is valid for redeeming:

a specified item or category of items only,

from the specified seller or sellers only,

within a specified period of time only.

All transactions are recorded in the database on a transaction by transaction basis. Each transaction is stored in the database as a record which incorporates various fields as illustrated in FIG. 5, such as:

“Transaction ID” field—key field that specifies a unique ID for each transaction

“Transaction type” field—specifies type of transaction (debit, credit, etc.)

“Reassignable” field—specifies whether the transaction can be reassigned to a third party

“Fragmentable” field—specifies whether the transaction can be fragmented into smaller amounts or has to be redeemed (or transferred, used, etc.) as a whole

“Sub-Account” field—specifies the sub-account to which the transaction is credited/debited

“Item ID” field—specifies the item or category of items that can be redeemed

“Item Description” field—a description of the item.

“Limitation” field—specifies any limitation, exclusion or restriction relating to the item that can be redeemed or to the method in which the item can be redeemed

“Buying power amount” field—specifies the monetary amount (undiscounted) that can be used to redeem the item

“Paid amount’ field—specifies the monetary amount (discounted) that buyer pays and seller receives for the item

“Overage” field—specifies an excess amount or rate that can be bought at the same discount rate

“Refundable” field—specifies a maximum amount or rate that can be refunded at the same discount rate

“Buyer ID” field—identifies buyer of item

“Buyer Group ID” field—identifies the group (if any) to which the buyer belongs

“Seller ID” field—identifies seller of item

“Seller Group ID” field—identifies the group (if any) to which the seller belongs

“Valid At” field—specifies the places where item can be redeemed

“Valid From” field—specifies the beginning date when item can be redeemed

“Valid Trough” field—specifies the end date when item can be redeemed

As previously mentioned with respect to FIG. 2b, a buyer account is assigned to each participating buyer (individual consumer, corporation, institution, etc.). The buyer account incorporates various inter-linked sub-accounts (such as a cash sub-account, credit sub-account, escrow sub-account, buyer power sub-account, etc.) and can also be linked to buyer's external accounts (such as a credit card account, checking/savings account, etc.) held by other participating financial institutions.

In order to fund the buyer account or to effect payments from it, funds can be transferred between the various sub-accounts and also between the sub-accounts and external accounts held by other participating financial institutions.

Also, conceivably, a buyer can transfer funds or reassign buying power amounts to the account of another buyer or seller.

As previously mentioned with respect to FIG. 3a, a seller account is assigned to each participating seller (merchant, manufacturer, provider, institution, etc.). Similarly, the seller account incorporates various inter-linked sub-accounts and links to external accounts and can conceivably transfer funds or reassign buying power amounts to the accounts of third parties.

The extent of database access privileges (privileges to “read” and/or “write” particular information/data) given to participants varies from one type of participant to another, and from one particular participant to another. While functionality issues broaden the extent of access privileges given to a participant, issues of tampering, security and privacy restrict it.

To perform various functions (e.g. transaction authorization, charging a sale, getting a report, posting a debit/credit, transferring funds, etc.), participants can access and/or record the data to which they respectively have privileges through various means of communication and available technologies, such as:

The Internet (e.g. buyer can access his account through the Internet to transfer funds between sub-accounts or to/from external accounts, or to get a detailed report)

24-Hour Banking machines or online kiosks

Online cash register

The telephone (e.g. a seller can seek authorization for a transaction before delivering an item to a buyer by using an automated phone access service or by speaking with a customer representative)

A magnetic car issued in conjunction with buyer account (e.g. a seller can ‘swipe’ the magnetic card to seek authorization for a transaction and to charge it to a buyer account)

A smart card application

Mail/fax (e.g. buyers receive periodic printed reports detailing account activity, or buyer faxes a form authorizing a fund transfer)

### EXAMPLE

An auction is started and 164 buyers join in, all with the same desire, to buy a new XYZ model automobile. Each buyer commits an amount of money they are interested in spending. In this case, let's assume 164 varied, individual amounts from $36,000 to $45,000. Also, each buyer declares a minimum desired discount rate, e.g., varied values between 5% and 17%. Sellers who retail these cars then commence repetitive bidding, offering discounts which start at 2%, and at auction close, end with a 17% bid from the winning seller. Note, the sellers can see the total available business to be won at all times during the auction. In this case, more than six million dollars of business is available at one auction for the winning seller.

At the auction close, all buyers who requested 17% discount or less receive their committed spending amounts (buying power) for their redemption of a particular model at the specified winning seller. The buyer's accounts are debited for the amount of their declared spending amount less the discount rate, e.g., $45,000 less 17% which equals $37,350. The buyer's declared spending amount ($45,000) is tracked by the financial system as that buyer's ‘buying power’ at the specific seller who won the bid. At any time following the auction, the buyer visits the seller and selects/redeems the specific vehicle of his choice (colors, options, etc.) at the normal retail prices. For this example, we can assume that the normal price (MSRP) of the buyer's selected car is $45,000. The buyer presents his account number, which is processed by the seller for verification and authorization through the financial credit system. The centralized financial database returns information to the seller that authorizes that person for the purchase of $45,000 worth of XYZ model at that seller during that time period.

The results of this simplified auction example:

1) 164 buyers received substantial savings for their desired vehicle (e.g., paid $37,350 for a car listed at $45,000).

2) The buyers avoided the haggling usually associated with buying a car.

3) The winning seller received more than $6,000,000 of new car sales at one auction.

The following is a limited list of potential products/services that could be auctioned at the Web site:

| | | |
|---|---|---|
| - Restaurant Food | - Automobiles | - Groceries |
| - Computer Equipment | - Insurance | - Gift Certificates |
| - Corporate Procurement | - Clothing | - Esthetic Services |
| - Children's Toys | - Sporting Goods | - Long Distance |
| - Office Products | - Audio/Video | Services |
| | Products | |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for conducting an online auction of a monetary amount for a specified item or category of items, the method comprising:
receiving at a computer site at least one bid having a discount rate for the specified item or category of items being auctioned from a plurality of sellers registered to participate in the auction;
receiving at the computer site a commitment to buy an undiscounted value amount of the item or an undiscounted value amount within the specified category of items at a minimum discount rate from at least one buyer registered to participate in the auction; and
declaring at least one successful seller of the value amount for the specified item or category of items based on the bid from the successful seller or sellers having the greatest discount rate greater than or equal to the minimum discount rate and best meeting the buyer's individual conditions.

2. The method as claimed in claim 1 wherein a commitment to buy an undiscounted value amount at a minimum discount rate is received from each of a plurality of buyers and wherein the method further comprises pooling the plurality of buyers to obtain various pooled award amounts and wherein the at least one successful seller is declared of his respective pooled award amount for the specified item or category of items.

3. The method as claimed in claim 1 wherein the items are products.

4. The method as claimed in claim 1 wherein the items are services.

5. The method as claimed in claim 2 wherein the plurality of buyers are independent and/or unrelated.

6. The method as claimed in claim 2 further comprising receiving at the computer site information representing a minimum award amount or predefined sequence of minimum award amounts corresponding to a predefined sequence of discount bids that each seller is willing to accept from the pooled buyers for a given category.

7. The method as claimed in claim 2 further comprising receiving at the computer site information representing a maximum award amount that a seller is capable of accepting and willing to accept from the pooled buyers.

8. The method as claimed in claim 1 further comprising receiving at the computer site information representing a method of guaranteeing the value amount from the at least one buyer.

9. The method as claimed in claim 1 wherein at least one seller is pre-approved to sell the specified item or category of items.

10. The method as claimed in claim 1 further comprising receiving at the computer site information representing any sellers unacceptable to the at least one buyer.

11. The method as claimed in claim 1 wherein the computer site is a Web site.

12. The method as claimed in claim 1 wherein the auction is a reverse auction.

13. The method as claimed in claim 1 wherein the auction ends a fixed period of time after the auction begins.

14. The method as claimed in claim 1 further comprising receiving at the computer site a command from the at least one buyer to try to end the auction for the at least one buyer wherein a successful seller of the value amount for the at least one buyer can be declared before the preset auction expiration time.

15. The method as claimed in claim 1 further comprising receiving at the computer site a command from the at least one buyer to try to end the auction for the at least one buyer wherein a successful seller of the value amount for the at least one buyer can be declared before the end of the auction.

16. The method as claimed in claim 1 wherein the successful seller is determined by the buyer's pre-defined conditions.

17. The method as claimed in claim 1 wherein the seller with the highest bid for discount rate is the successful seller.

18. The method as claimed in claim 1 wherein there is more than one successful seller for a given auction.

19. The method as claimed in claim 1 wherein a buyer account is assigned to the registered buyer.

20. The method as claimed in claim 19 wherein the buyer account includes various inter-linked sub-accounts.

21. The method as claimed in claim 20 wherein the sub-accounts are linked to at least one external account of the registered buyer held by a financial institution.

22. The method as claimed in claim 21 wherein the buyer's funds can be transferred between the various sub-accounts and also between the sub-accounts and external accounts held by other financial institutions.

23. The method as claimed in claim 22 wherein the registered buyer can transfer funds or reassign buying power amounts to the account of another registered buyer or a registered seller.

24. The method as claimed in claim 1 wherein a seller account is assigned to each registered seller.

25. The method as claimed in claim 24 wherein the seller account includes various inter-linked sub-accounts.

26. The method as claimed in claim 25 wherein the sub-accounts are linked to at least one external account of the at least one seller held by a financial institution.

27. The method as claimed in claim 26 wherein the seller's funds can be transferred between the various sub-accounts and also between the sub-accounts and external accounts held by other financial institutions.

28. The method as claimed in claim 27 wherein the at least one registered seller can transfer funds or reassign buying power amounts to the account of another registered buyer or a registered seller.

29. The method as claimed in claim 1 wherein the step of receiving at least one bid includes receiving a bidding table for at least one seller in which the at least one seller commits to a sequence of bids corresponding to a sequence of value amounts for a given category.

30. The method as claimed in claim 1 wherein each of the sellers is pre-approved to sell the specified item or category of items.

31. The method as claimed in claim 1 wherein the auction ends an undetermined period of time after the auction begins.

32. A computer site for conducting an online auction of a monetary amount for a specified category of items, the computer site comprising:
a set of related documents and associated files; and
a server for serving up the set of related documents and associated files to a plurality of I/O devices to provide buyers and sellers with capability to participate in the auction, the server being programmed with application software to:
receive at least one bid having a discount rate for the specified item or category of items being auctioned from a plurality of sellers registered to participate in the auction;
receive a commitment to buy an undiscounted value amount of the item or an undiscounted value amount within the specified category of items at a minimum discount rate from at least one buyer registered to participate in the auction; and
declare a successful seller of the value amount for the specified item or category of items based on a bid from the successful seller or sellers having the greatest discount rate greater than or equal to the minimum discount rate and best meeting the buyer's individual conditions.

33. The computer site as claimed in claim 32 wherein a commitment to buy an undiscounted value amount at a minimum discount rate is received from each of a plurality of buyers and wherein the server is further programmed to pool the plurality of buyers to obtain various pooled award amounts and wherein the at least one successful seller is declared his respective pooled award amount for the specified category of items.

34. The computer site as claimed in claim 32 wherein the items are products.

35. The computer site as claimed in claim 32 wherein the items are services.

36. The computer site as claimed in claim 33 wherein the plurality of buyers are independent and/or unrelated.

37. The computer site as claimed in claim 33 further comprising receiving at the computer site information representing a minimum award amount or predefined sequence of minimum award amounts corresponding to a predefined sequence of discount bids that each seller is willing to accept from the pooled buyers for a given category.

38. The computer site as claimed in claim 33 further comprising receiving at the computer site information representing a maximum award amount that a seller is capable of accepting and willing to accept from the pooled buyers.

39. The computer site as claimed in claim 32 wherein the server is further programmed to receive information representing a method of guaranteeing the value amount from the at least one buyer.

40. The computer site as claimed in claim 32 wherein at least one seller is pre-approved to sell the specified item or category of items.

41. The computer site as claimed in claim 32 wherein the server is further programmed to receive information representing any sellers unacceptable to the at least one buyer.

42. The computer site as claimed in claim 32 wherein the computer site is a Web site.

43. The computer site as claimed in claim 32 wherein the auction is a reverse auction.

44. The computer site as claimed in claim 32 wherein the auction ends a fixed period of time after the auction begins.

45. The computer site as claimed in claim 32 further comprising receiving at the computer site a command from the at least one buyer to try to end the auction for the at least one buyer wherein a successful seller of the value amount for the at least one buyer can be declared before the preset auction expiration time.

46. The computer site as claimed in claim 32 wherein the server is further programmed to receive a command from the at least one buyer to try to end the auction for the at least one buyer wherein a successful seller of the value amount for the at least one buyer can be declared before the end of the auction.

47. The computer site as claimed in claim 32 wherein the successful seller is determined by the buyer's pre-defined conditions.

48. The computer site as claimed in claim 32 wherein the seller with the highest bid for discount rate is the successful seller.

49. The computer site as claimed in claim 32 wherein there is more than one successful seller for a given auction.

50. The computer site as claimed in claim 32 wherein a buyer account is assigned to the registered buyer.

51. The computer site as claimed in claim 50 wherein the buyer account includes various inter-linked sub-accounts.

52. The computer site as claimed in claim 51 wherein the sub-accounts are linked to at least one external account of the registered buyer held by a financial institution.

53. The computer site as claimed in claim 52 wherein the buyer's funds can be transferred between the various sub-accounts and also between the sub-accounts and external accounts held by other financial institutions.

54. The computer site as claimed in claim 53 wherein the registered buyer can transfer funds or reassign buying power amounts to the account of another registered buyer or a registered seller.

55. The computer site as claimed in claim 32 wherein a seller account is assigned to each registered seller.

56. The computer site as claimed in claim 55 wherein the seller account includes various inter-linked sub-accounts.

57. The computer site as claimed in claim 56 wherein the sub-accounts are linked to at least one external account of the at least one seller held by a financial institution.

58. The computer site as claimed in claim 57 wherein the seller's funds can be transferred between the various sub-accounts and also between the sub-accounts and external accounts held by other financial institutions.

59. The computer site as claimed in claim 58 wherein the at least one registered seller can transfer funds or reassign buying power amounts to the account of another registered buyer or a registered seller.

60. The computer site as claimed in claim 32 wherein the server is further programmed to receive a bidding table for at least one seller in which the at least one seller commits to a sequence of bids corresponding to a sequence of value amounts for a given category.

61. The computer site as claimed in claim 32 wherein each of the sellers is pre-approved to sell the specified item or category of items.

62. The computer site as claimed in claim 32 wherein the auction ends an undetermined period of time after the auction begins.

63. A computer-implemented auction system for negotiating discount credits between sellers offering at least one pre-defined category of goods or service items and buyers wishing to purchase goods or service items selected from said category, comprising:
an auction system that presents a first interface for access by buyers in communicating willingness to purchase items selected from a pre-defined category at a negotiated category discount and a second interface for access by sellers in communicating willingness to offer items selected from the pre-defined category;
the first interface including a commitment amount field through which each buyer communicates the amount that buyer will commit to spend and a requested discount field through which each buyer communicates the smallest discount that buyer will accept;
a data storage associated with the auction engine for storing the identity of buyers who have communicated willingness to purchase items from the pre-defined category, and for storing bid data indicative of the commitment amount and requested discount communicated by each buyer;
the auction system further having a compilation system that analyzes the bid data to present information to sellers through the second interface indicative of the aggregate commitment amounts associated with different requested discounts;
the second interface having a discount offer field through which each seller communicates the discount that seller is willing to offer;
a commitment system having a mechanism for terminating negotiation in response to a pre-defined criterion and for identifying a selected seller that has offered the greatest discount during the negotiation;
the commitment system communicating with the auction system to generate a discount record for at least a portion of the buyers identified in the data store, each discount record including the identity of the buyer and seller, the pre-defined category on which the buyer negotiated and data indicative of the commitment amount and the discount offered by the selected seller.
